(19) United States
(12) Patent Application Publication
(10) Pub. No.: US 2013/0127984 A1
(43) Pub. Date: May 23, 2013

(54) System and Method for Fast Tracking and Visualisation of Video and Augmenting Content for Mobile Devices

(71) Applicant: Tudor Alexandru GRECU, Bucharest (RO)

(72) Inventor: Tudor Alexandru GRECU, Bucharest (RO)

(21) Appl. No.: 13/674,284

(22) Filed: Nov. 12, 2012

Related U.S. Application Data
(60) Provisional application No. 61/558,453, filed on Nov. 11, 2011.

(51) Int. Cl. H04N 5/232

(52) U.S. Cl. CPC H04N 5/23238
USPC 348/36

(57) ABSTRACT

The present invention relates to a method and an apparatus for panoramic visualization on hand held and similar devices. The hand held devices consist of at least a camera sensor, a CPU and a display module, and often consisting of one or more additional sensor such as accelerometer, magnetometer or gyroscope. The main features of the system consist of a sub-system for displaying on-line augmented reality content, building in the same time a panoramic view, a sub-system for off-line displaying of panoramic augmented reality content and a user trigger to commute between the two modes. By alternating the on-line and off-line phases, the system provides ease of use as well as reduced energy consumption to the device. The system does not attempt to build a mosaic panoramic image. It temporary stores the acquired video frames together with their relative position with respect to each other.

### FIELD OF THE INVENTION

The present invention relates to a method and an apparatus for panoramic visualization on hand held and similar devices.

### BACKGROUND OF THE INVENTION

In some of the applications on hand held devices, such as those of augmented reality, the user is exploring the surrounding area by naturally moving around the camera of the hand-held device while receiving additional digital information overlaid on top of the video image. It is useful in such circumstances to provide the user with the ability to integrate the captured video and digital information into a panoramic view that spans the surveyed area.

The building and visualization of panoramic images from multiple snapshot images or a video stream is known to be used for several applications. The general process consists of aligning a set of images (or video frames) and then stitch them together into a larger mosaic image that can be subsequently be stored, visualized in different modes, etc.

The typical methods known to the skilled in the art include two main approaches:
feature point detection followed by feature point correspondence.
feature point selection followed by template matching.

The first approach often relies on gradient information which has the advantage of being robust to changes in light conditions. The second approach relies on direct use of the grayvalues, which recommends it when image contrast is low. Both methods are relatively intensive computationally, particularly the template matching phase.

The majority of offered solutions suffer from two drawbacks:
the computational load incurred by the aligning and stitching processes is generally high, making it unsuitable for low computational power platforms such as mobile devices, where it induces waiting time and CPU load—and consequently energy loss;
the stitching process introduces visualization artefacts, especially when blending together images containing a multitude of independently moving objects, which is the typical case in urban context.

Furthermore, the two issues above are generally speaking related in the sense that techniques that aim for better artefacts treatment are also more computationally demanding.

Lately, a number of software applications targeted on mobile devices are built around the concept of augmented reality. The term refers to systems where the user is presented with a faithful representation of the reality—such as a display of the data captured by a video camera—on top of which, an artificially generated information is added, this artificial information ‘reacting’ coherently with the reality, thus augmenting the experience. An example of such augmented reality applications is the display of the 9 meter free-kick area over the football field in tv transmissions, or the impact point of the tennis ball.

The primary user intent in the context of augmented reality applications is that of hic et nunc information finding, thus the panoramic visualization needs to be provided fast, but it's lifetime is relatively short, not likely to be further used after relevant information is obtained. This is in opposition to the common usage of panoramic images that are intended for persistent storage and multiple visualizations. Also, in the described use case, it is highly desirable to avoid as much as possible the stitching artefacts, as they confuse the user perception of the scene with respect to the digital content overlaid on top of it.

It is therefore an object of this invention to provide a method that offers a panoramic visualization for camera enabled hand held devices that is fast and stitching artefacts free.

### SUMMARY OF THE INVENTION

The invention is embodied in a method and system for visualization of augmented reality content on hand-held and similar devices.

The computing system environment is that of hand held devices consisting of at least a camera sensor, a CPU and a display module, and often consisting of one or more additional sensors such as accelerometer, magnetometer, gyroscope, etc.

The main features of the system consist of:
a sub-system for displaying on-line augmented reality content while in the same time building a panoramic view
a sub-system for off-line displaying of panoramic augmented reality content
a user trigger to commute between the two modes.

By alternating the on-line and off-line phases, the system provides ease of use as well as reduced energy consumption to the device.

The key feature of the system is that it does not attempt to build at any point a mosaic panoramic image, as this is time consuming and error prone; instead it temporary stores the acquired video frames together with their relative position with respect to each other. When the user intends to visualize a certain part of the panoramic field of view, the system selects and displays the stored image frame that is the closest match to the desired part of the field of view. The system makes use of the high redundancy of the video frames and trades-off memory consumption—which is high, for simplicity and low computational effort.

The on-line stage comprises of:
Obtaining a real-time video stream from a camera of a hand held device and optionally one or multiple streams of data from one or multiple sensors, such as accelerometer, magnetometer, gyroscope, GPS.
Calculating the camera pose of the currently acquired frame of the video stream and selectively compressing and storing it into the processor memory.
Displaying the real-time video stream and any associated digital content.

The off-line stage comprises of:
Switching-off the real-time video stream and all of the multiple additional sensors
Obtaining from user interaction commands such as panning (left, right, up, down) and zoom-in.
Calculating which stored image corresponds best with the current desired portion of the field of view.
Decompressing and displaying the said best corresponding image.
Displaying any associated digital content on top of the image.

### DESCRIPTION OF THE DRAWINGS

FIG. 1 schematically illustrates a system implementing the visualization process according to the embodiment of the invention.

FIG. 2 schematically illustrates the predefined placement of feature rectangular areas over an image canvas. The rectangular features are grouped in concentrically aligned formations of 4 rectangles of increasing size—e.g. R1, R2, R3, R4. A number of such formations are spread equidistantly on the image canvas, thus creating a full set of 112 rectangular regions of various positions and sizes.

FIG. 3. illustrates the image matching process.

FIG. 4 schematically illustrates the graphical element for representation and control of the panoramic viewing area.

### DETAILED DESCRIPTION

The general description of the panoramic visualization engine was described in the summary section.

In this section the preferred embodiment for the critical steps, such as the image tracking/orientation calculation and image selection, will be described.

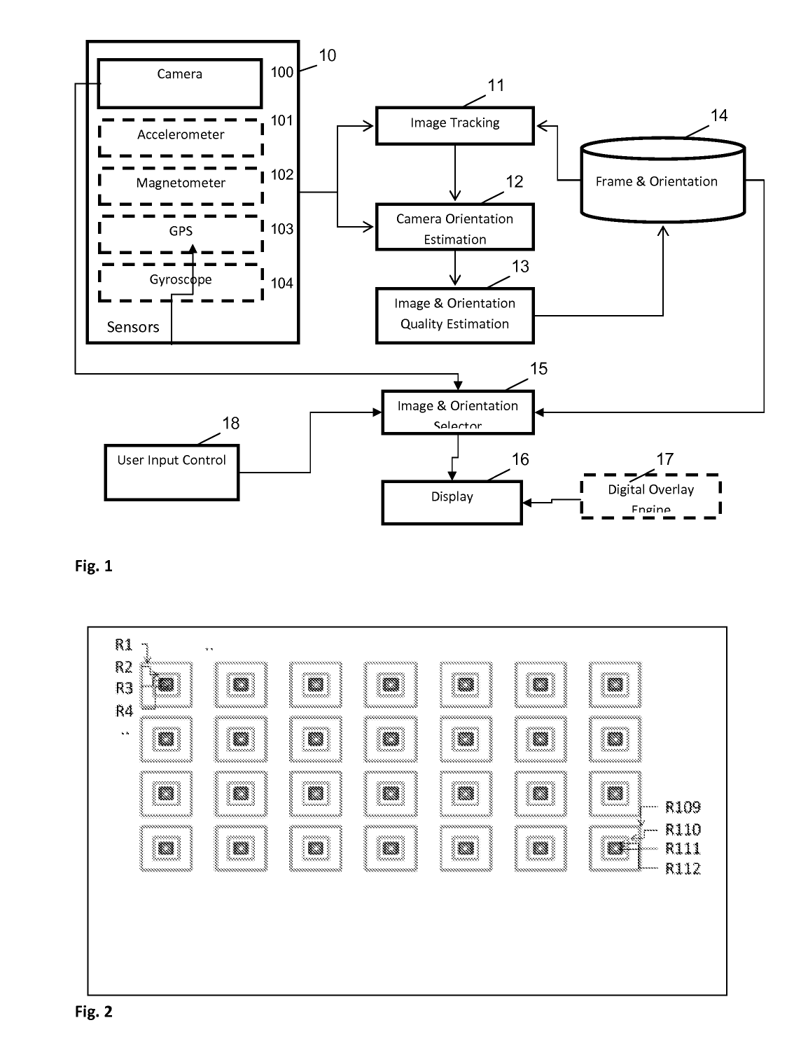

In a preferred embodiment, resulting from FIG. 1, the image and information acquisition system includes a camera (101) and additional sensors like accelerometer (102), magnetometer (103), GPS (104), gyroscope (105). Other sensors could be added.

The calculation of image tracking (11) and camera orientation estimation (12) are critical for the performance of the system. In a preferred embodiment, the image tracking system is designed to be as computationally lightweight as possible, while being in the same time robust to typical image conditions, such as low light, or multiple moving objects.

The calculation of the displacement between individual frames can be done solely by means of image analysis (module 11), or by fusing image analysis with data from the additional sensors (module 12).

The selection of image content to be displayed is handled by modules 14 and 15.

The displaying of image (16) may be optionally accompanied by additional digital information (17) describing the viewed scene.

The overall user interaction is handled by module 18.

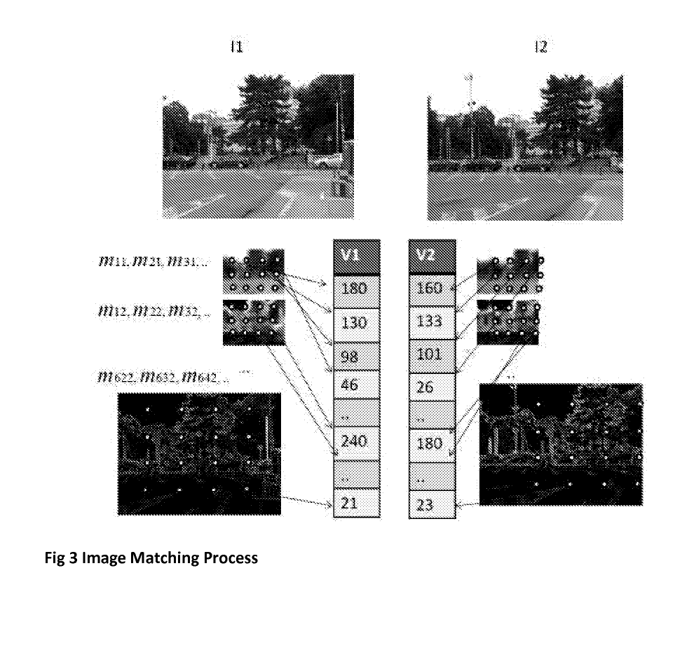

In the preferred embodiment we opt for a scheme that avoids the altogether the feature detection and the gradient calculation. The method to compute the displacement between frame 11 and 12, described in FIG. 2 and FIG. 3, comprises the following steps:
1. Consider a predefined set of R=[R1, R2, . . . Rn] of rectangular areas of various sizes and positions over the image canvas. The rectangular areas are unconstrained in terms of overlapping.
2. Define the characteristic feature vector a rectangular area Rx as being the vector M=[m1, m2, m3, m4] of statistical moments computed over the greyscale values in area Rx. The statistical moments used are selected from moments up to 4′th degree—mean, variance, skewness, kurtosis.
3. Further define the characteristic feature vector of image I as the superset of characteristic feature vectors of each rectangular area in R, i.e. V=[m11, m12, . . . m14, m21, m22, . . . mn4]
4. Slide the set R of rectangles over image 12, and search for the position where the characteristic feature vector of 11 (V1)—matches best the characteristic feature vector of 12 (V2).

The predefined size and position of the set of rectangles is obtained by off-line analysis of a large number of videos obtained in representative situations. The use of a predefined set of rectangles instead of a set resulted from the analysis of the concrete image content has the advantage of time saving but embodiments where the selection is adaptive with respect to image content are also conceivable.

The computation of statistical moments over rectangular areas is efficiently implemented using integral images, a technique well known in the literature.

The search of optimum match performed at step 4 may be done in exhaustive manner, but in a preferred embodiment it follows a multiresolution heuristic search where the matching is first performed by using the largest rectangular areas in order to obtain a rough estimation of the displacement, and then progressively adding the smaller rectangular areas to achieve accuracy around the rough estimation from previous stages.

The camera orientation module (12) is responsible for fusing information from image tracking with additional information from sensors. In particular, the accelerometer and magnetometer provide estimation of the yaw, pitch and roll angles of the camera. These estimates are corrupted by various sources of errors and can be improved by combining them with image tracking estimates by means of Kalman filtering, complementary filtering, or other techniques.

The image and orientation quality module (13) is responsible to assess if the current image is going to be stored into the ring-buffer storage area. Due to the inherently finite size of the memory or bandwidth, a maximum upper limit of memory usage must be defined for the module 14 in practical terms. The storage area can be found on the device itself or on external servers, the frame and orientation module (14) being responsible for the replacement policy based on memory or bandwidth limitations.

The module 13 provides a replacement policy that optimizes the informational content offered to the user. The maximization of information content takes into account the overlapping between each image and the set of the other existing ones, the computational effort to execute the replacement, as well as the intrinsic quality of the image, by such criteria as blur, luminosity, noise, etc. The process establishes the appropriate replacement action to take is and executes it at each step. In a preferred embodiment the replacement module is using a fuzzy logic engine based on linguistic rules, such as:
IF image IS old THEN good candidate for replacement
IF image IS highly overlapping THEN good candidate for replacement
IF image IS at range border THEN bad candidate for replacement
IF image IS tracking quality low THEN good candidate for replacement

The image and associated data selector module (15) is performing different tasks depending of whether the system is in on-line or off-line mode. When system is in on-line mode, the current image from the camera is always displayed; therefore the module is a simple pass-through filter. When the system is in off-line visualization mode, the current user-desired orientation—obtained from 18—is compared with the available orientations in the ring-buffer (14), and the closest match is retained.

One common problem encountered when user performs camera panning, is the fact that the position of the camera on the non-dominant movement is slightly fluctuating. For example, when user moves camera around in horizontal plane, there are small fluctuations on the vertical camera position. When re-displaying selected images in off-line mode, these slight vertical misalignments may be disturbing. To counteract the effect, the selector module 15 adjusts the orientation of each selected image based on the history of recently displayed images and a forecast of images that will be further displayed, with the goal to organize a smooth visual transition. This step is algorithmically implemented in preferred embodiment by means of dynamic programming.

The user input control (18) is responsible for triggering the transition between off-line and on-line phases, as well as controlling the desired viewing area from the panoramic space. The transition to off-line phase triggers also the management of the sensors. The sensors can be turned off totally or partially either immediately or using an idle time-out timer.

The user control can be based on gestures or conventional GUI elements. In a preferred Embodiment—where the device is equipped with accelerometer sensors—the transition on-line to off-line is triggered by moving the device camera plane from near vertical orientation, to near horizontal orientation. The off-line to on-line transition is treated similarly. In another embodiment—where the device is equipped with a touch-screen, the transition from on-line to off-line is done whenever the user touches the touch-screen, regardless of the position of the touch. The off-line to on-line transition is done by a GUI element—such as a button.

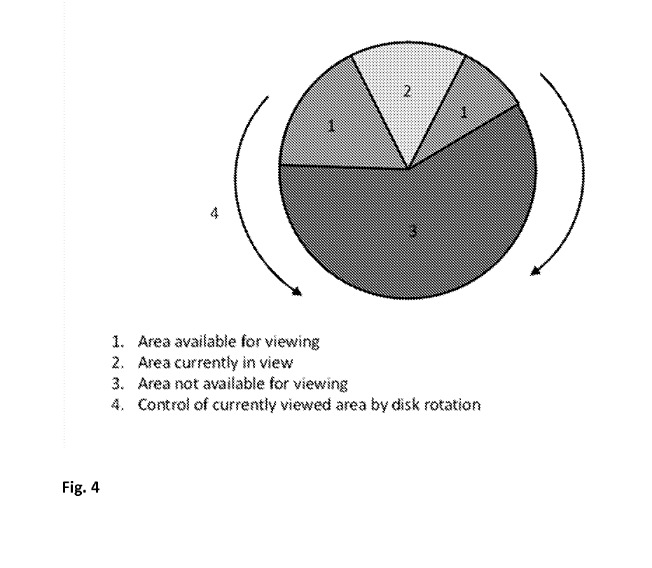

The user is allowed to pan the active field of view along the dominant direction, as well as zooming in. At any moment the user is viewing a subset of the available viewing area, which is itself a subset of the total 360 degrees area. To ease the user understanding of the geometrical relationship between the areas, a graphic representation is used. In the preferred embodiment the graphical representation is depicted in FIG. 4. The currently viewing area 1 remains always in same vertical position as it represents the user view. The opening of the sector 2 is equal to the angular view of the actual camera on the hand-held device. The available panoramic area 1 and the non-visible area 3 can be solidly rotated so that a different part of the viewing space is becoming the current viewing area.

What is claimed is:

1. a system comprising (a) tracking of images, of system position, and of additional information by means of a plurality of sensors where at least one such sensor is a video camera, (b) analyzing such images and additional information by means of a quality estimation process, (c) storing the selected images and additional information in a specific memory storage area, (d) displaying the images with additional information in an order that is based on various or interchanging criteria, at least one such criteria being the display of most-recent image and data, and at least one other such criteria being the display of a preselected most-representative image and data, relative to a desired geoposition.

2. a system of claim 1, wherein the displaying can be realized in two alternative or permanently interchanging modes: an on-line display mode of most-recent images and additional information including augmented reality content, when the plurality of sensors are active, or an off-line display mode providing panoramic viewing functionality, when all, or a part of, the sensors are turned off or in a standby state,

3. the system of claim 1, wherein the images and corresponding information are tracked, analyzed and stored on a hand held device comprising at least a display, a CPU and a camera sensor, or on other similar devices comprising the same elements.

4. the system of claim 1, wherein the displayed off-line images are selected based on statistical calculation and indicators, including several display orders computed over rectangular regions of suitably chosen based on relative position and size.

5. the system of claim 4, wherein the computation of displacement between two frames 11 and 12, in off-line mode, follows the following four steps a. creation of R as rectangular areas of various sizes and positions over the initial image canvas of 11; b. creation of a feature vector Rx as vector of statistical moments computed over Rx, these statistical moments being selected from moments up to 4^{th} degree—mean, variance, skewness, kurtosis; c. creation of characteristic feature vector of image 11 as a superset of characteristic feature vector of each rectangular area in R; d. sliding the set R of rectangles over the second image and searching for position where characteristic feature vector of 11 matches best the characteristic feature vector of 12.

6. the system of claim 5, wherein the on-line or off-line modes of the system which includes the different sensors, with consequent on-line or off-line display of information and images, is commuted by the user by means of a trigger or is automatically selected by the displaying device or by the sensors.

7. the system of claim 6, wherein the trigger can consist in the fast change of the almost vertical position of hand held device into almost horizontal position and vice-versa

8. the system of claim 6, wherein the trigger can consist in the touching of the hand held screen

9. the system of claim 1, wherein the display of images is accompanied by a visual control of the available view angle, based on the off-line stored Images and the on-line available views

10. A method for panoramic visualisation on hand-held devices including the following steps: a. tracking of images and of additional information by means of sensors, b analyzing such images and additional information by means of a quality estimation process, c storing the selected images and additional information in a specific memory ring-buffer storage area, this step including the sub-step of c.1. selecting and of c.2. replacing the images and additional information based on pre-defined quality and orientation rules, d displaying the images with additional information on the hand-held display.
